(19) United States
(12) Patent Application Publication
(10) Pub. No.: US 2010/0274822 A1
(43) Pub. Date: Oct. 28, 2010

(54) DATA CONVERTING METHOD, DATA CONVERTING DEVICE, TERMINAL, AND SERVER

(75) Inventors: Haitao Liu, Shenzhen (CN); Rui Wang, Shenzhen (CN); Yue Song, Shenzhen (CN)

Correspondence Address: Docket Clerk/HTCL, P.O. Drawer 800889, Dallas, TX, 75380, US

(73) Assignee: Huawei Technologies Co., Ltd

(21) Appl. No.: 12/831,904

(22) Filed: Jul. 7, 2010

Related U.S. Application Data
(63) Continuation of application No. PCT/CN2008/073153, filed on Nov. 21, 2008.

(30) Foreign Application Priority Data
Feb. 2, 2008 (CN) 200810026243.7

(51) Int. Cl. G06F 7/00; G06F 17/30

(52) U.S. Cl. 707/809; 707/E17.055

(57) ABSTRACT

A data converting method is provided, which includes the following steps. Data of a terminal is acquired. A data model corresponding to the received data is confirmed to be an object data model. The data based on the object data model is converted into data based on a treelike data model. A data converting device, a terminal, and a server are further provided. Thus, the data based on the object data model is converted into the data based on the treelike data model, so that a server of an Open Mobile Alliance (OMA) Device Management (DM) protocol can manage a terminal based on the object data model defined by a Digital Subscriber Line (DSL) forum.

### CROSS-REFERENCE TO RELATED APPLICATIONS

This application is a continuation of International Application No. PCT/CN2008/073153, filed on Nov. 21, 2008, which claims priority to Chinese Patent Application No. 200810026243.7, filed on Feb. 2, 2008, both of which are hereby incorporated by reference in their entireties.

### TECHNICAL FIELD

The present invention relates to a communications technology, and more particularly to a data converting method, a data converting device, a terminal, and a server.

### BACKGROUND

An Open Mobile Alliance (OMA) Device Management (DM) implements settings of mobile device related parameters by using an OMA DM protocol. The parameters are organized through a tree structure with internal nodes and leaf nodes, are based on eXtensible Marked Language (XML), and comply with the XML Document Type Defined (DTD) of the OMA DM. A management tree is stored on a terminal device in the OMA DM structure. The management tree can be considered as an interface through which one device management server manages the terminal device through the DM protocol. Basic components of the management tree are nodes, which are classified into internal nodes and leaf nodes. The internal nodes may further have lower-level internal nodes and leaf nodes, while the leaf nodes do not have lower-level nodes anymore. A Management Object (MO) serving as a sub-tree of the management tree is a set of nodes associated to realize a certain particular function.

In a general case, in a wireless environment, the OMA DM protocol is adopted for management, and the OMA DM data model is a treelike data model, while in a fixed network environment, a Customer premises equipment Wide Area Network (WAN) Management Protocol (CWMP) is adopted for management, and the CWMP data model is an object data model. With the development of wireless communications technologies, such as Wireless Fidelity (WIFI) and World Interoperability for Microwave Access (WIMAX), although the fixed networks provide a mobile function through a wireless channel, the service provision manner of the networks falls within a scope of the fixed network. When WIFI is converged with the wireless communications manners, such as, Wideband Code Division Multiple Access (WCDMA), generally an OMA DM server is adopted to manage a terminal. However, the OMA DM server manages a terminal device based on the OMA DM data model, so that the existing OMA DM server can not effectively manage a terminal device based on the CWMP data model in a network environment.

### SUMMARY

The present invention is directed to a data converting method, a data converting device, a terminal and a server, so that a server of data based on a treelike data model manages a terminal of data based on an object data model.

In order to solve the technical problem, in an embodiment, the present invention provides a data converting method, which includes the following steps. Data of a terminal is acquired. A data model corresponding to the received data is confirmed to be an object data model. The data based on the object data model is converted into data based on a treelike data model.

In an embodiment, the present invention further provides a data converting device, which includes an acquiring unit, a confirming unit, a data converting unit, and a sending unit.

The acquiring unit is configured to acquire data of a terminal.

The confirming unit is configured to confirm that a data model corresponding to the received data is an object data model.

The data converting unit is configured to convert the data based on the object data model into data based on a treelike data model.

The sending unit is configured to send the data based on the treelike data model to a server.

In an embodiment, the present invention further provides a terminal, which includes a first data converting unit and a sending unit.

The first data converting unit is configured to convert data based on an object data model into data based on a treelike data model.

The sending unit is configured to send the data based on the treelike data model to a server.

In an embodiment, the present invention further provides a server, which includes an acquiring unit, a second data converting unit, and a management unit.

The acquiring unit is configured to acquire data from a terminal.

The second data converting unit is configured to convert data based on an object data model from the terminal into data based on a treelike data model.

The management unit is configured to manage the data based on the treelike data model.

Through the embodiments of the present invention, the data based on the object data model is converted into the data based on the treelike data model, so that a server of an OMA DM protocol can manage the terminal based on the object data model defined by a Digital Subscriber Line (DSL) forum.

### BRIEF DESCRIPTION OF THE DRAWINGS

To illustrate the technical solution according to the embodiments of the present invention or in the prior art more clearly, the accompanying drawings for describing the embodiments or the prior art are given below. Apparently, the accompanying drawings in the following description are only some embodiments of the present invention, and persons of ordinary skill in the art can derive other drawings from the accompanying drawings without creative efforts.

FIG. 1 is a schematic flow chart of a data converting method according to a first embodiment;

FIG. 2 is a schematic flow chart of a data converting method according to a second embodiment;

FIG. 3 is a schematic structural view of data based on a treelike data model after data conversion according to an embodiment;

FIG. 4 is a schematic structural view of a data converting device according to an embodiment;

FIG. 5 is a schematic structural view of a data converting unit in a data converting device according to an embodiment;

FIG. 6 is a schematic structural view of a terminal according to an embodiment; and

FIG. 7 is a schematic structural view of a server according to an embodiment.

### DETAILED DESCRIPTION

In order to make the objectives, technical solution and merits of the present invention clearer, a detailed description of the present invention is hereinafter given below with reference to accompanying drawings.

Embodiments of the present invention provide a data converting method, which includes the following steps. Data of a terminal is acquired. A data model corresponding to the received data is confirmed to be an object data model. The data based on the object data model is converted into data based on a treelike data model. The present invention further provides a corresponding data converting device, a terminal, and a server.

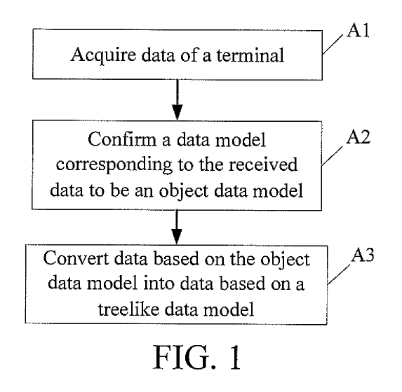

FIG. 1 is a schematic flow chart of a data converting method according to a first embodiment of the present invention. Referring to FIG. 1, the method includes the following steps.

In step A1, data of a terminal is acquired.

Here, the data of the terminal refers to a management operation instruction, a management operation object, and ordinary subscriber data, such as, an address book and a short message.

In step A2, a data model corresponding to the received data is confirmed to be an object data model.

Here, the received data is confirmed to be data based on a CWMP data model. In the CWMP, the data model includes two types of elements: object and parameter. The object may include other objects and parameters, while the parameter gives a specific parameter name and a parameter value. A “.” is added behind an object name in the CWMP data model, and a lower level object is identified by cascading its own name behind a name of an upper-level object. The cascade of the object name is referred to as a full path name, and names are separated by the “.”. However, names of all parameters do not have the “.”. The object and the element can be effectively distinguished due to the difference, and a previous level object is determined according to the full path name of the object.

In step A3, the data based on the object data model is converted into data based on a treelike data model.

Here, different elements are processed based on the difference of the names of the object and the names of the parameter in the CWMP data model. The data based on the CWMP data model is converted into data based on an OMA DM data model. Basic components of the management tree in the OMA DM data model are nodes, which are classified into internal nodes and leaf nodes. The internal nodes may further have lower-level internal nodes and leaf nodes, while the leaf node does not have lower-level modes any more.

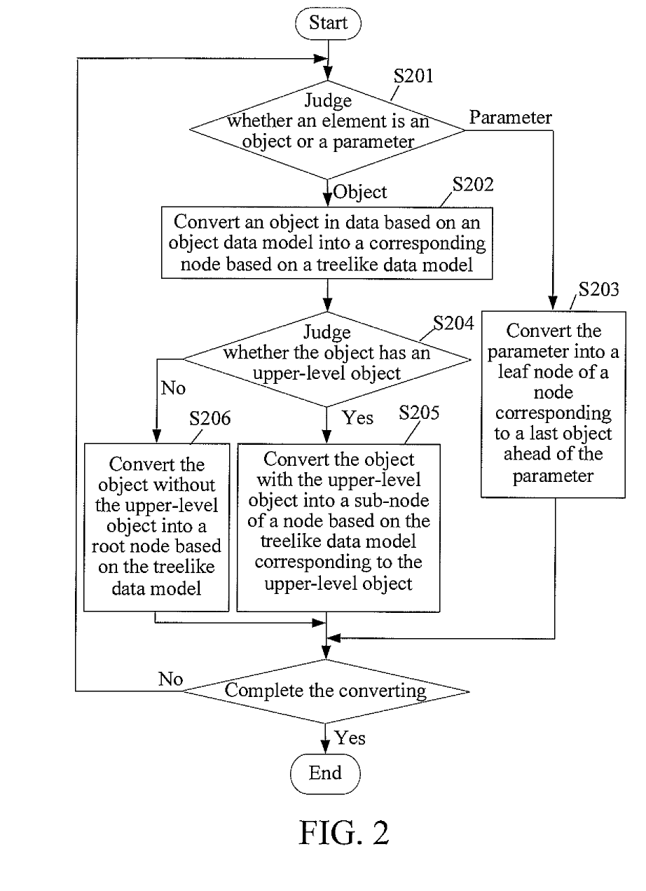

FIG. 2 is a schematic flow chart of a data converting method according to a second embodiment of the present invention. Referring to FIG. 2, the method is described in detail hereinafter.

In step S201, it is judged whether an element is an object or a parameter. If the element is the object, step S202 is executed. Otherwise, step S203 is executed.

Here, it is judged whether the element is the object or the parameter by using an element name in data based on a CWMP data model. A “.” is added behind an object name in the CWMP data model, and a lower level object is identified by cascading its own name behind a name of an upper-level object. The cascade of the object name is referred to as a full path name, and names are separated by the “.”. However, names of all parameters do not have the “.”.

In step S202, an object in data based on an object data model is converted into a corresponding node based on a treelike data model.

In step S203, the parameter is converted into a leaf node of a node corresponding to a last object ahead of the parameter.

In step S204, it is judged whether the object has an upper-level object. If yes, step S205 is executed. Otherwise, step S206 is executed.

Here, according to the object name, it is judged whether the object has the upper-level object. A “.” is added behind an object name in the CWMP data model, and a lower level object is identified by cascading its own name behind a name of an upper-level object. The cascade of the object name is referred to as a full path name, and names are separated by the “ ”. It is judged whether the object has the upper-level object through the full path name of the object.

In step S205, the element is converted into a sub-node of a node based on the treelike data model corresponding to the upper-level object.

Here, the process of converting the element into the sub-node of the node based on the treelike data model corresponding to the upper-level object includes the following steps. It is judged whether the node based on the treelike data model corresponding to the upper-level object exists. If the judging result is yes, the element is converted into the sub-node of the node based on the treelike data model corresponding to the upper-level object. If the judging result is no, firstly the upper-level object is converted into the node based on the treelike data model, and then the element is converted into the sub-node of the node based on the treelike data model corresponding to the upper-level object.

In step S206, the element is converted into a root node based on the treelike data model.

Here, if it is confirmed that the element does not have the upper-level object according to the full path name of the object, the element is converted into the root node based on the treelike data model.

One specific example of a method for converting from the data based on the CWMP data model to the data based on the OMA DM data model is described in the following. Received data information is a CWMP data configuration document of one actual Internet gateway device. Content of the configuration document is described in the following. The CWMP configuration document:

InternetGatewayDevice.
DeviceSummary = “InternetGatewayDevice: 1.0[ ] (Baseline: 1),
ABCService: 1.0[1] (Baseline: 1),
XYZService: 1.0[1] (Baseline: 1)”
LANDeviceNumberOfEntries = 5
WANDeviceNumberOfEntries = 2
InternetGatewayDevice.DeviceInfo.
Manufacturer = “ABC Ltd”
ManufacturerOUI = AAAAAA
InternetGatewayDevice.DeviceInfo.VendorConfigFile.1.
Name = “Latest.cfg”
Version = 1.2
Date = 20051001T090909Z
Description = “Written by AAA”
InternetGatewayDevice.Layer3Forwarding.
DefaultConnectionService
=“InternetGatewayDevice.WANDevice.1.WANConnectionDevice.2.W
ANPPPConnection.1”
ForwardNumberOfEntries = 4

The description is given in the following.

InternetGatewayDevice. is an object type, which represents a gateway device.

DeviceSummary is a parameter type, and DeviceSummary=“InternetGatewayDevice: 1.0[ ] (Baseline: 1), ABC Service: 1.0 [1] (Baseline: 1), XYZService: 1.0 [1] (Baseline: 1)” refers to an object type supported by the gateway device.

LANDeviceNumberOfEntries is a parameter type, and LANDeviceNumberOfEntries=5 means that the gateway device has five Local Area Network (LAN) devices.

WANDeviceNumberOfEntries is a parameter type, and WANDeviceNumberOfEntries=2 means that a terminal device has two WAN devices.

InternetGatewayDevice.DeviceInfo. is an object type, which means that general device information is included.

Manufacturer=“ABC Ltd” refers to a manufacturer.

ManufacturerOUI=AAAAAA refers to a unique identification number of the manufacturer.

InternetGatewayDevice.DeviceInfo.VendorConfigFile.1. is an object type, which represents a specific configuration document of the manufacturer.

Name is a parameter type, and Name=“Latest.cfg” refers to a specific name of the configuration document.

Version is a parameter type, and Version=1.2 refers to a specific version number of the configuration document.

Date is a parameter type, and Date=20051001T090909Z refers to a specific date of the configuration document.

Description is a parameter type, and Description=“Written by AAA” refers to an author of the configuration document.

InternetGatewayDevice.Layer3Forwarding. is an object type, which represents one service defaulted in Layer 3.

DefaultConnectionService is a parameter type, and DefaultConnectionService=“InternetGatewayDevice.WANDevice.1.WANConnectionDevice.2.WANPPPConnection.1” refers to a connection of WAN PPP.

ForwardNumberOfEntries is a parameter type, and ForwardNumberOfEntries=4 refers to four forwarded services.

The CWMP configuration document is the data based on the object data model, according to the element type in the data, the element is converted into the node corresponding to the treelike model.

In the CWMP configuration document, the element InternetGatewayDevice is an object, and does not have the upper-level object, so that the object InternetGatewayDevice is converted into a root node of the OMA DM data model. The following elements DeviceSummary, LANDeviceNumberOfEntries, and WANDeviceNumberOfEntries are parameters, and a last object ahead of them is the InternetGatewayDevice, so that the parameters DeviceSummary, LANDeviceNumberOfEntries, and WANDeviceNumberOfEntries are converted into leaf nodes of a node corresponding to the InternetGatewayDevice, and values of the parameters DeviceSummary, LANDeviceNumberOfEntries, and WANDeviceNumberOfEntries are assigned to the values of the corresponding leaf nodes after the parameters are converted. The element InternetGatewayDevice.DeviceInfo is an object, and it is a cascade of two names. The DeviceInfo has an upper-level object InternetGateway, and a node corresponding to the InternetGateway has been generated, so that the DeviceInfo is converted into a sub-node of the node corresponding to the InternetGatewayDevice. Because the DeviceInfo is not a parameter, it is not necessary to assign the value to the DeviceInfo. Both the elements Manufacturer and ManufacturerOUI are parameters, and a last object ahead of them is the DeviceInfo, so that the parameters Manufacturer and ManufacturerOUI are converted into leaf nodes of a node corresponding to the object DeviceInfo, and values of the parameters Manufacturer and ManufacturerOUI are assigned to the corresponding leaf nodes after the parameters are converted. The element InternetGatewayDevice.DeviceInfo.VendorConfigFile.1 is an object, and its name is a cascade of four names. An upper-level object of the “1” is the VendorConfigFile, and an upper-level object of the VendorConfigFile is the DeviceInfo, so that the VendorConfigFile is a sub-node of the DeviceInfo. Because the VendorConfigFile does not have the corresponding node yet, firstly a node corresponding to the VendorConfigFile is generated, and then the “1” is converted into a sub-node of the node corresponding to the VendorConfigFile. Because the “1” is not a parameter, it is not necessary to assign the value. The elements Name, Version, Date, and Description are all parameters, and a last object ahead of them is the “1”, so that the parameters Name, Version, Date, and Description are converted into leaf nodes of a node corresponding to the object “1”, and values of the parameters Name, Version, Date, and Description are assigned to the corresponding leaf nodes after the parameters are converted. The element InternetGatewayDevice.Layer3Forwarding is an object, and its name is a cascade of two names. An upper-level object of the Layer3Forwarding is the InternetGatewayDevice, and a node corresponding to the upper-level object InternetGatewayDevice has been generated, so that the Layer3Forwarding is converted into a sub-node of the InternetGatewayDevice. The elements DefaultConnectionService and ForwardNumberOfEntries are parameters, and a last object ahead of them is the object Layer3Forwarding, so that the parameters DefaultConnectionService and ForwardNumberOfEntries are converted into leaf nodes of a node corresponding to the Layer3Forwarding, and then values of the parameters DefaultConnectionService and ForwardNumberOfEntries are assigned to the corresponding leaf nodes after the parameters are converted. In a process of converting the object into the node, according to an association relation between the node and the object, a name of the node is nominated as a name of the object. In a process of converting the parameter into the leaf node, according to an association relation between the leaf node and the parameter, a name of the leaf node is nominated as a name of the parameter, and a value of the parameter is assigned to the leaf node corresponding to the parameter. The nomination method is convenient for a server of the OMA DM protocol to manage a terminal based on the object data model defined by the DSL forum, and the nomination method may also adopt a self-defined nomination manner. In a data converting method according to the embodiment of the present invention, the data configuration document of the actual Internet gateway device based on the CWMP data model is converted into the data based on the OMA DM data model, and the server manages the converted data configuration document of the actual Internet gateway device based on the treelike data model, so that the server of the OMA DM protocol can manage the terminal based on the object data model defined by the DSL forum.

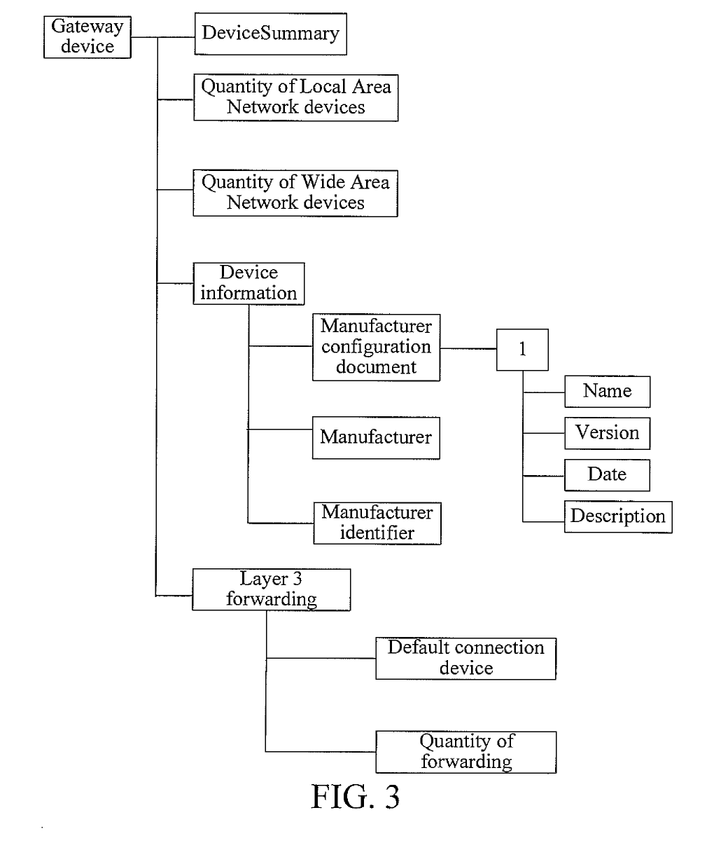

FIG. 3 is a schematic structural view of data based on a treelike data model after data conversion according to an embodiment of the present invention. Referring to FIG. 3, the converted CWMP configuration document is as shown in FIG. 3.

A data converting device, a terminal, and a server corresponding to the embodiments of the method are described in detail hereinafter.

FIG. 4 is a schematic structural view of a data converting device according to an embodiment of the present invention. Here, the data converting device serves as an independent network element device. The network element device can be simultaneously corresponding to a plurality of terminals, and convert data based on an object data model from each terminal into data based on a treelike data model, so that a server of the OMA DM protocol can manage a terminal based on the object data model defined by the DSL forum. Definitely, the network element device may also be simultaneously corresponding to a plurality of OMA DM servers.

The data converting device includes an acquiring unit 1, a confirming unit 2, a data converting unit 3, and a sending unit 4.

The acquiring unit 1 is configured to acquire data of a terminal.

Here, the data of the terminal refers to a management operation instruction, a management operation object, and ordinary subscriber data, e.g., an address book and a short message.

The confirming unit 2 is configured to confirm that a data model corresponding to the received data is an object data model.

Here, according to a name of data of the object data model, the data model corresponding to the received data is confirmed to be the object data model.

The data converting unit 3 is configured to convert the data based on the object data model into data based on a treelike data model.

Here, the confirming unit 2 communicates with the data converting unit 3, and the data converting unit 3 converts the data based on the object data model confirmed by the confirming unit 2 into the data based on the treelike data model.

The sending unit 4 is configured to send the data based on the treelike data model to a server.

Here, the data based on the treelike data model is sent to the server, and the server manages the data based on the treelike data model.

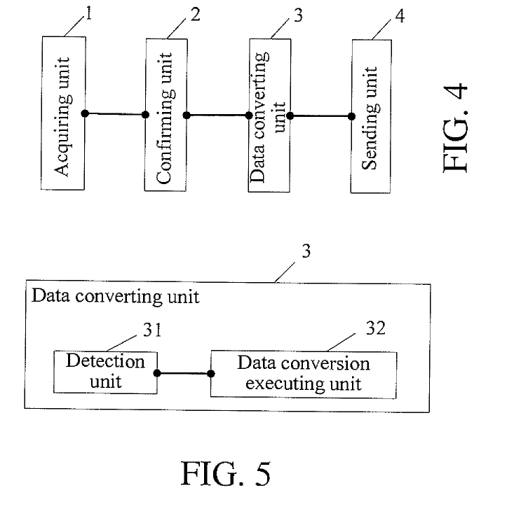

FIG. 5 is a schematic structural view of a data converting unit in a data converting device according to an embodiment of the present invention. The data converting unit 3 includes a detection unit 31 and a data conversion executing unit 32.

The detection unit 31 is configured to detect a type of an element in data based on an object data model, and generate a corresponding detection result.

Here, it is detected whether the element is an object or a parameter by using an element name in data based on a CWMP data model. A “.” is added behind an object name in the CWMP data model, and a lower level object is identified by cascading its own name behind a name of an upper-level object. The cascade of the object name is referred to as a full path name, and names are separated by the “.”However, names of all parameters do not have the “.”.

The data conversion executing unit 32 is configured to convert a parameter into a leaf node based on the treelike data model when the detection result of the detection unit is that the element is the parameter; convert the element into a sub-node of a node based on the treelike data model corresponding to an upper-level object of an object when the detection result of the detection unit is that the element is the object, and the object has the upper-level object; and convert the element into a root node based on the treelike data model when the detection result of the detection unit is that the element is an object, and the object does not have the upper-level object.

Here, the process of converting the element in the data based on the object data model into the leaf node based on the treelike data model includes the following step. When the element in the data based on the object data model is identified to be a parameter, the parameter is converted into a leaf node of a node corresponding to a last object ahead of the parameter. The process of converting the element into the sub-node of the node based on the treelike data model corresponding to the upper-level object includes the following steps. It is judged whether the node based on the treelike data model corresponding to the upper-level object exists, if yes, the element is converted into the sub-node of the node based on the treelike data model corresponding to the upper-level object, and if not, firstly the upper-level object is converted into the node based on the treelike data model, and then the element is converted into the sub-node of the node based on the treelike data model corresponding to the upper-level object. In the process of converting the object into the node, according to an association relation between the node and the object, a name of the node is nominated as a name of the object. In the process of converting the parameter into the leaf node, according to an association relation between the leaf node and the parameter, a name of the leaf node is nominated as a name of the parameter, and a value of the parameter is assigned to the leaf node corresponding to the parameter.

The data converting device serves as an independent network element device. The network element device can be simultaneously corresponding to a plurality of terminals, convert the data based on the object data model from each terminal into data based on the treelike data model, and then send the data based on the treelike data model to a server, so that a server of the OMA DM protocol can manage a terminal based on the object data model defined by the DSL forum. Definitely, the network element device may also be simultaneously corresponding to a plurality of OMA DM servers.

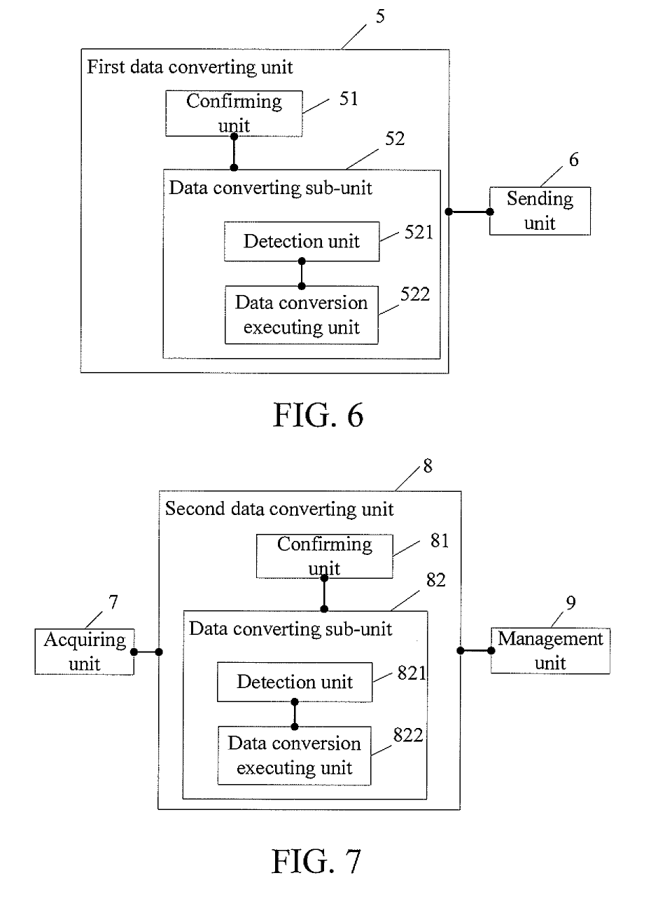

FIG. 6 is a schematic structural view of a terminal according to an embodiment of the present invention. The terminal includes a first data converting unit 5 and a sending unit 6.

The first data converting unit 5 is configured to convert data based on an object data model into data based on a treelike data model.

The first data converting unit 5 includes a confirming unit 51 and a data converting sub-unit 52.

The confirming unit 51 is configured to confirm that a data model corresponding to the received data is the object data model.

Here, according to a name of data of the object data model, the data model corresponding to the received data is confirmed to be the object data model.

The data converting sub-unit 52 is configured to convert the data based on the object data model into the data based on the treelike data model.

Here, the confirming unit 51 communicates with the data converting sub-unit 52, and the data converting sub-unit 52 converts the data based on the object data model confirmed by the confirming unit 51 into the data based on the treelike data model. The data converting sub-unit 52 includes a detection unit 521 and a data conversion executing unit 522.

The detection unit 521 is configured to detect a type of an element in the data based on the object data model, and generate a corresponding detection result.

Here, it is detected whether the element is an object or a parameter by using an element name in data based on a CWMP data model. A “.” is added behind an object name in the CWMP data model, and a lower level object is identified by cascading its own name behind a name of an upper-level object. The cascade of the object name is referred to as a full path name, and names are separated by the “.”. However, names of all parameters do not have the “.”.

The data conversion executing unit 522 is configured to convert a parameter into a leaf node based on the treelike data model when the detection result of the detection unit is that the element is the parameter; convert the element into a sub-node of a node based on the treelike data model corresponding to an upper-level object of an object when the detection result of the detection unit is that the element is the object, and the object has the upper-level object; and convert the element into a root node based on the treelike data model when the detection result of the detection unit is that the element is an object, and the object does not have the upper-level object.

Here, the process of converting the element in the data based on the object data model into the leaf node based on the treelike data model includes the following step. When the element in the data based on the object data model is identified to be a parameter, the parameter is converted into a leaf node of a node corresponding to a last object ahead of the parameter. The process of converting the element into the sub-node of the node based on the treelike data model corresponding to the upper-level object includes the following steps. It is judged whether a node based on the treelike data model corresponding to the upper-level object exists, if yes, the element is converted into the sub-node of the node based on the treelike data model corresponding to the upper-level object, and if not, firstly the upper-level object is converted into the node based on the treelike data model, and then the element is converted into the sub-node of the node based on the treelike data model corresponding to the upper-level object. In the process of converting the object into the node, according to an association relation between the node and the object, a name of the node is nominated as a name of the object. In the process of converting the parameter into the leaf node, according to an association relation between the leaf node and the parameter, a name of the leaf node is nominated as a name of the parameter, and a value of the parameter is assigned to the leaf node corresponding to the parameter.

The sending unit 6 is configured to send the data based on the treelike data model to a server.

Here, the data based on the treelike data model is sent to the server. The server manages the data based on the treelike data model.

The first data converting unit is disposed in the terminal. The first data converting unit converts the data based on the object data model of the terminal into the data based on the treelike data model, and then sends the data based on the treelike data model to the server, so that a server of the OMA DM protocol can manage a terminal based on the object data model defined by the DSL forum.

FIG. 7 is a schematic structural view of a server according to an embodiment of the present invention. The server includes an acquiring unit 7, a second data converting unit 8, and a management unit 9.

The acquiring unit 7 is configured to acquire data from a terminal;

Here, the data of the terminal refers to a management operation instruction, a management operation object, and ordinary subscriber data, e.g., an address book and a short message.

The second data converting unit 8 is configured to convert data based on an object data model from the terminal into data based on a treelike data model.

The second data converting unit 8 includes a confirming unit 81 and a data converting sub-unit 82.

The confirming unit 81 is configured to confirm a data model corresponding to the data received by the acquiring unit 7 to be an object data model.

Here, according to a name of data of the object data model, it is confirmed that the data model corresponding to the received data to be the object data model.

The data converting sub-unit 82 is configured to convert the data based on the object data model into the data based on the treelike data model.

Here, the confirming unit 81 communicates with the data converting sub-unit 82, and the data converting sub-unit 82 converts the data based on the object data model confirmed by the confirming unit 81 into the data based on the treelike data model. The data converting sub-unit 82 includes a detection unit 821 and a data conversion executing unit 822.

The detection unit 821 is configured to detect a type of an element in the data based on the object data model, and generate a corresponding detection result.

Here, it is detected whether the element is an object or a parameter by means of an element name in data based on a CWMP data model. A “.” is added behind an object name in the CWMP data model, and a lower level object is identified by cascading its own name behind a name of an upper-level object. The cascade of the object name is referred to as a full path name, and names are separated by the “.”. However, names of all parameters do not have the “.”.

The data conversion executing unit 822 is configured to convert a parameter into a leaf node based on the treelike data model when the detection result of the detection unit is that the element is the parameter; convert the element into a sub-node of a node based on the treelike data model corresponding to an upper-level object of an object when the detection result of the detection unit is that the element is the object, and the object has the upper-level object; and convert the element into a root node based on the treelike data model when the detection result of the detection unit is that the element is an object, and the object does not have the upper-level object.

Here, the process of converting the element in the data based on the object data model into the leaf node based on the treelike data model includes the following step. When the element in the data based on the object data model is identified to be a parameter, the parameter is converted into a leaf node of a node corresponding to a last object ahead of the parameter. The process of converting the element into the sub-node of the node based on the treelike data model corresponding to the upper-level object includes the following steps. It is judged whether a node based on the treelike data model corresponding to the upper-level object exists, if yes, the element is converted into the sub-node of the node based on the treelike data model corresponding to the upper-level object, and if not, firstly the upper-level object is converted into the node based on the treelike data model, and then the element is converted into the sub-node of the node based on the treelike data model corresponding to the upper-level object. In the process of converting the object into the node, according to an association relation between the node and the object, a name of the node is nominated as a name of the object. In the process of converting the parameter into the leaf node, according to an association relation between the leaf node and the parameter, a name of the leaf node is nominated as a name of the parameter, and a value of the parameter is assigned to the leaf node corresponding to the parameter.

The management unit 9 is configured to manage the data based on the treelike data model.

The second data converting unit is disposed in the server. The second data converting unit converts the data based on the object data model from the terminal into the data based on the treelike data model, so that a server of the OMA DM protocol can manage a terminal based on the object data model defined by the DSL forum.

A data converting method according to the embodiments of the present invention can be implemented through a program and related hardware. The program may be stored in a computer readable storage medium. The storage medium may be a Read-Only Memory (ROM), a Random Access Memory (RAM), a magnetic disk, or a Compact Disk Read-Only Memory (CD-ROM).

Through a data converting method, a data converting device, a terminal and a server according to the embodiments of the present invention, data based on a CWMP data model is converted into data based on an OMA DM data model, so that a server of the OMA DM protocol can manage a terminal based on an object data model defined by the DSL forum.

The above descriptions are merely some exemplary embodiments of the present invention, but not intended to limit the scope of the present invention. Any modification, equivalent replacement, or improvement made according to the appended claims of the present invention should fall within the scope of the present invention.

What is claimed is:

1. A data converting method, comprising:
acquiring data of a terminal;
confirming that a data model corresponding to the received data is an object data model; and
converting the data based on the object data model into data based on a treelike data model.

2. The method according to claim 1, wherein after the converting the data based on the object data model into the data based on the treelike data model, the method further comprises:
sending the data based on the treelike data model to a server; or
managing the data based on the treelike data model.

3. The method according to claim 2, wherein the converting the data based on the object data model into the data based on the treelike data model comprises:
judging whether an element in the data based on the object data model is an object, if yes, converting the element in the data based on the object data model into a corresponding node based on the treelike data model, and if not, converting the element in the data based on the object data model into a leaf node based on the treelike data model.

4. The method according to claim 3, wherein the converting the element in the data based on the object data model into the corresponding node based on the treelike data model comprises:
judging whether the element has an upper-level object according to a name of the element in the data based on the object data model, if yes, converting the element into a sub-node of a node based on the treelike data model corresponding to the upper-level object, and if not, converting the element into a root node based on the treelike data model.

5. The method according to claim 4, wherein the converting the element into the sub-node of the node based on the treelike data model corresponding to the upper-level object comprises:
judging whether the node based on the treelike data model corresponding to the upper-level object exists, if yes, converting the element into the sub-node of the node based on the treelike data model corresponding to the upper-level object, and if not, firstly converting the upper-level object into the node based on the treelike data model, and then converting the element into the sub-node of the node based on the treelike data model corresponding to the upper-level object.

6. The method according to claim 3, wherein the converting the element in the data based on the object data model into the leaf node based on the treelike data model comprises:
converting a parameter into a leaf node of a node corresponding to a last object ahead of the parameter, when identifying the element in the data based on the object data model is the parameter.

7. The method according to claim 4, further comprising:
using a name of the object as a name of the node according to an association relation between the node and the object, when converting the object into the node; and
using a name of the parameter as a name of the leaf node according to an association relation between the leaf node and the parameter, when converting the parameter into the leaf node, and assigning a value of the parameter to the leaf node corresponding to the parameter.

8. A data converting device, comprising:
an acquiring unit, configured to acquire data of a terminal;
a confirming unit, configured to confirm a data model corresponding to the received data to be an object data model;
a data converting unit, configured to convert the data based on the object data model into data based on a treelike data model; and
a sending unit, configured to send the data based on the treelike data model to a server.

9. The data converting device according to claim 8, wherein the data converting unit comprises:
a detection unit, configured to detect a type of an element in the data based on the object data model, and generate a corresponding detection result; and
a data conversion executing unit, configured to convert a parameter into a leaf node based on the treelike data model when the detection result of the detection unit is that the element is the parameter;
convert the element into a sub-node of a node based on the treelike data model corresponding to an upper-level object of an object when the detection result of the detection unit is that the element is the object, and the object has the upper-level object; and convert the element into a root node based on the treelike data model when the detection result of the detection unit is that the element is an object, and the object does not have the upper-level object.

10. A terminal, comprising:
a first data converting unit, configured to convert data based on an object data model into data based on a treelike data model; and
a sending unit, configured to send the data based on the treelike data model to a server.

11. The terminal according to claim 10, wherein the first data converting unit comprises:
a confirming unit, configured to confirm a data model corresponding to the received data to be the object data model; and
a data converting sub-unit, configured to convert the data based on the object data model into the data based on the treelike data model.

12. The terminal according to claim 11, wherein the data converting sub-unit comprises:
a detection unit, configured to detect a type of an element in the data based on the object data model, and generate a corresponding detection result; and
a data conversion executing unit, configured to convert a parameter into a leaf node based on the treelike data model when the detection result of the detection unit is that the element is the parameter;
convert the element into a sub-node of a node based on the treelike data model corresponding to an upper-level object of an object when the detection result of the detection unit is that the element is the object, and the object has the upper-level object; and convert the element into a root node based on the treelike data model when the detection result of the detection unit is that the element is an object, and the object does not have the upper-level object.

13. A server, comprising:
an acquiring unit, configured to acquire data from a terminal;
a second data converting unit, configured to convert data based on an object data model from the terminal into data based on a treelike data model; and
a management unit, configured to manage the data based on the treelike data model.

14. The server according to claim 13, wherein the second data converting unit comprises:
a confirming unit, configured to confirm a data model corresponding to the data received by the acquiring unit to be an object data model; and
a data converting sub-unit, configured to convert the data based on the object data model into the data based on the treelike data model.

15. The server according to claim 14, wherein the data converting sub-unit comprises:
a detection unit, configured to detect a type of an element in the data based on the object data model, and generate a corresponding detection result; and
a data conversion executing unit, configured to convert a parameter into a leaf node based on the treelike data model when the detection result of the detection unit is that the element is the parameter; convert the element into a sub-node of a node based on the treelike data model corresponding to an upper-level object of an object when the detection result of the detection unit is that the element is the object, and the object has the upper-level object; and convert the element into a root node based on the treelike data model when the detection result of the detection unit is that the element is an object, and the object does not have the upper-level object.
